(19) United States
(12) Patent Application Publication
(10) Pub. No.: US 2011/0043852 A1
(43) Pub. Date: Feb. 24, 2011

(54) DOCUMENT OUTPUT DEVICE, COMPUTER READABLE MEDIUM AND DOCUMENT OUTPUT METHOD

(75) Inventors: Hiroyoshi UEJO, Kanagawa (JP); Hiroshi Niina, Kanagawa (JP); Kazuhiro Ohya, Kanagawa (JP); Katsuya Koyanagi, Kanagawa (JP); Chihiro Matsuguma, Kanagawa (JP); Zhenrui Zhang, Kanagawa (JP); Ayumi Onishi, Kanagawa (JP)

Correspondence Address: OLIFF & BERRIDGE, PLC, P.O. BOX 320850, ALEXANDRIA, VA, 22320-4850, US

(73) Assignee: FUJI XEROX CO., LTD., Tokyo (JP)

(21) Appl. No.: 12/795,262

(22) Filed: Jun. 7, 2010

(30) Foreign Application Priority Data
Aug. 24, 2009 (JP) 2009-193469

(51) Int. Cl. G06F 3/12

(52) U.S. Cl. 358/1.15

(57) ABSTRACT

A document output device includes an acquisition unit and a controller. When a printed document is read by a reading device and output of the document on the basis of read document information is instructed, the acquisition unit acquires at least one of attribute information of a document receiver, attribute information of an output instructor, and second identification information inputted by the output instructor. If it is determined, on the basis of a first identification information and the acquired information, that an output of a constituent element specified as an object of output restriction is not permitted, the controller restricts the output of the constituent element which is the object of output restriction in the document.

### CROSS-REFERENCE TO RELATED APPLICATION

This application is based on and claims priority under 35 USC 119 from Japanese Patent Application No. 2009-193469 filed Aug. 24, 2009.

### BACKGROUND

### Technical Field

The present invention relates to a document output device, a computer readable medium storing a document output program, and a document output method

### SUMMARY

According to an aspect of the invention, there is provided a document output device including: an acquisition unit that acquires at least one of attribute information of a document receiver who is to receive an outputted document, attribute information of an output instructor, or second identification information inputted by the output instructor, when a printed document is read with a reading device, and output of the document on the basis of read document information acquired by the reading is instructed; and a controller that controls output of the document so as to restrict output of a constituent element which is an object of output restriction in the document to be outputted on the basis of the read document information, if it is determined that the output of the constituent element specified as the object of output restriction is not permitted on the basis of a first identification information which is extracted from the read document information, and the information acquired by the acquisition unit.

### BRIEF DESCRIPTION OF THE DRAWINGS

Exemplary embodiments of the present invention will be described in detail based on the following figures, wherein:

FIG. 1 is a block diagram illustrating schematic structure of a computer system relating to a first exemplary embodiment.

FIGS. 2A and 2B are sequence diagrams illustrating a flow of processing of the first exemplary embodiment.

FIG. 3A is an image diagram illustrating an example of a document created by a user.

FIG. 3B is an image diagram illustrating an example of a document that is printed with authentication information embedded in an output-restricted object constituent element.

FIG. 4 is a flowchart illustrating details of document output processing that is performed by image reading and printing processing relating to the first exemplary embodiment.

FIG. 5A to FIG. 5C are image diagrams respectively illustrating examples of outputted documents.

FIG. 6 is a block diagram illustrating schematic structure of a computer system relating to a second exemplary embodiment.

FIGS. 7A and 7B are sequence diagrams illustrating a flow of processing of the second exemplary embodiment.

FIG. 8A is an image diagram illustrating an example of a document that is printed with output-restricted object constituent elements and rights information specified.

FIG. 8B is an image diagram illustrating an example of a document that is outputted in accordance with instructions of output instructors at various levels of superiority.

FIG. 8C is an image diagram illustrating another example of a document that is outputted in accordance with instructions of output instructors at various levels of superiority.

FIG. 9 is a flowchart illustrating details of document distribution processing that is performed by an administrative server relating to the second exemplary embodiment.

### DETAILED DESCRIPTION

Herebelow, examples of embodiments of the present invention are described in detail with reference to the attached drawings.

### First Exemplary Embodiment

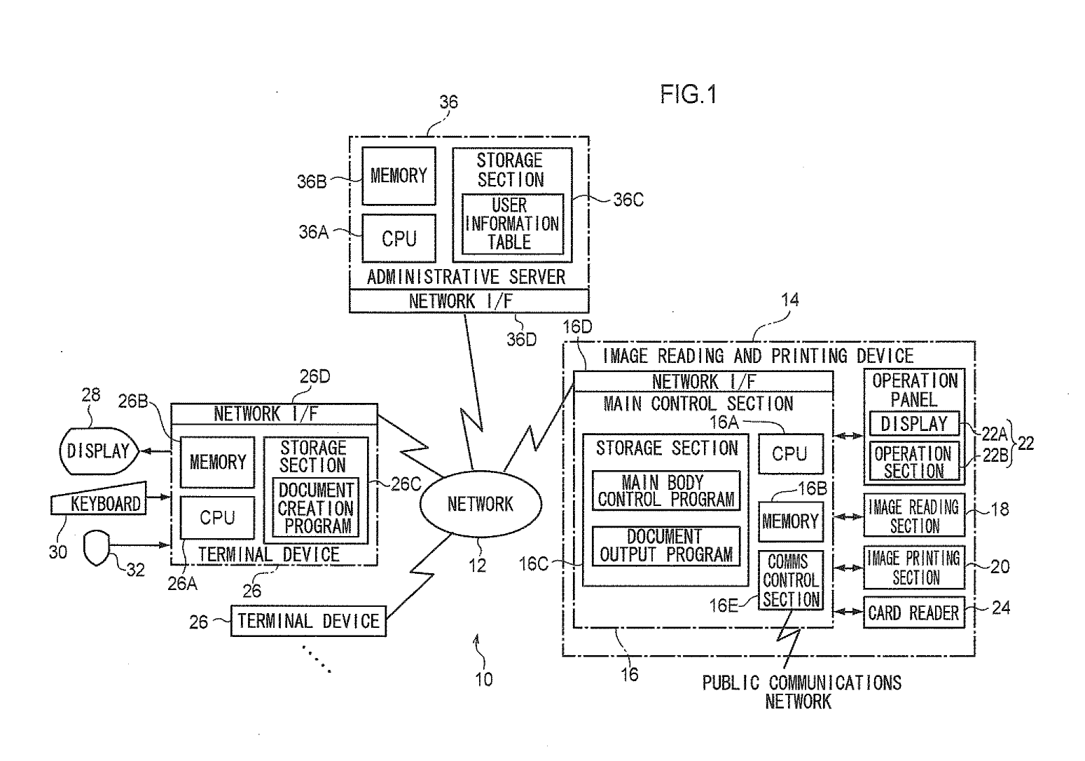

FIG. 1 illustrates schematic structure of a computer system 10 relating to the present first exemplary embodiment. An image reading and printing device 14, a plural number of terminal devices 26 constituted by personal computers (PCs) and the like, and an administrative server 36 are respectively connected to a network 12 constituted by a LAN or the like to structure the computer system 10.

The image reading and printing device 14 may be constituted by a device that is provided with a combination of the functions of a copier, the functions of a printer, the functions of a facsimile machine and the functions of a scanner, or the like. The image reading and printing device 14 is equipped with a main control section 16 constituted by a microcomputer or the like, in which are incorporated a CPU 16A, a memory 16B, a non-volatile storage section 16C constituted with a hard disk drive (HDD), flash memory or the like, a network interface (I/F) section 16D and a communications control section 16E. An image reading section 18, an image printing section 20, an operation panel 22 and a card reader 24 are each connected to the main control section 16. The image reading section 18 optically reads a reading target document placed thereon (a paper original) and outputs reading image data. The image printing section 20 prints an image represented by inputted reading image data onto paper. The operation panel 22 is provided with a display 22A, which is a display constituted with an LCD or the like, and an operation section 22B, which is an input unit constituted with a ten-key pad, a touch panel or the like. The card reader 24 reads information recorded on IC cards (not shown) that are respectively carried by individual users of the computer system 10.

The network I/F section 16D of the main control section 16 is connected to the network 12, and manages communications with the terminal devices 26 via the network 12. The communications control section 16E is connected to a public communications network (not illustrated) and manages communications via the public communications network with other devices that are provided with the functions of facsimile machines. A main body control program, for controlling operations of each section of the image reading and printing device 14 and providing various services to users, and a document output program, for performing below-described document output processing with the CPU 16A, are each installed in the storage section 16C of the main control section 16 as programs to be executed by the CPU 16A. The various services are, for example, copying of documents, printing (printing of documents represented by document data received from the terminal devices 26), facsimile transmission, scan-to-box (a service that reads a document and saves the read image data to a pre-specified save region in the storage section 16C), scan-to-mail (a service that reads a document, attaches the read image data to an e-mail and sends the same), and the like.

The aforementioned document output program is an aspect of the document output program relating to the present invention. In this first exemplary embodiment, this document output program is executed by the CPU 16A of the main control section 16 of the image reading and printing device 14. Thus, the image reading and printing device 14 functions as the document output device relating to the present invention.

The individual terminal devices 26 are each provided with a CPU 26A, a memory 26B, a non-volatile storage section 26C constituted with an HDD, flash memory or the like, and a network I/F section 26D. The terminal device 26 is connected to the network 12 via the network I/F section 26D. A display 28, a keyboard 30 and a mouse 32 are each connected to the terminal device 26. An operating system (OS) program and various application programs, including a document creation application program described below, are installed in the storage section 26C of the terminal device 26.

The administrative server 36 is provided with a CPU 36A, a memory 36B, a non-volatile storage section 36C constituted with an HDD, flash memory or the like, and a network I/F section 36D. The administrative server 36 is connected to the network 12 via the network I/F section 36D. An OS program, application programs for realizing the functions of the administrative server 36 and the like (not shown) are installed in the storage section 36C of the administrative server 36, and a user information table is stored in the storage section 36C. The user information table respectively registers, for individual users of the computer system 10, a user ID, authentication information (for example, a password or the like), information representing a superiority level (for example, 3 for the management level, 2 for the administrative level, 1 for ordinary users) and suchlike.

Next, operation of the first exemplary embodiment is described. In the computer system 10 relating to this first exemplary embodiment, numerous documents are created by users operating the terminal devices 26, and the created documents are printed onto recording papers by the image reading and printing device 14. Among the documents created and printed by the users, there will be documents that, although created with the assumption that they will be distributed to numbers of people, have portions of information in the documents that it would be undesirable to show to all of the plural people who are document distribution targets (document receivers), in view of confidentiality and the like. Information that is portions of documents and that is desirably not shown to some of the document receivers includes, for example: in documents relating to new products, illustrations and the like showing designs of the new products; in documents relating to financial statements, tables showing financial data prior to a shareholders' general meeting; roadmap charts in documents relating to business strategies; and so forth. When a document in which the desirable scope of disclosure differs between document receivers as described above is to be distributed to a number of document receivers, it is necessary to provisionally create the document, and then respectively create and output plural document files that differ from one another in respect of ranges of the created document that are disclosed.

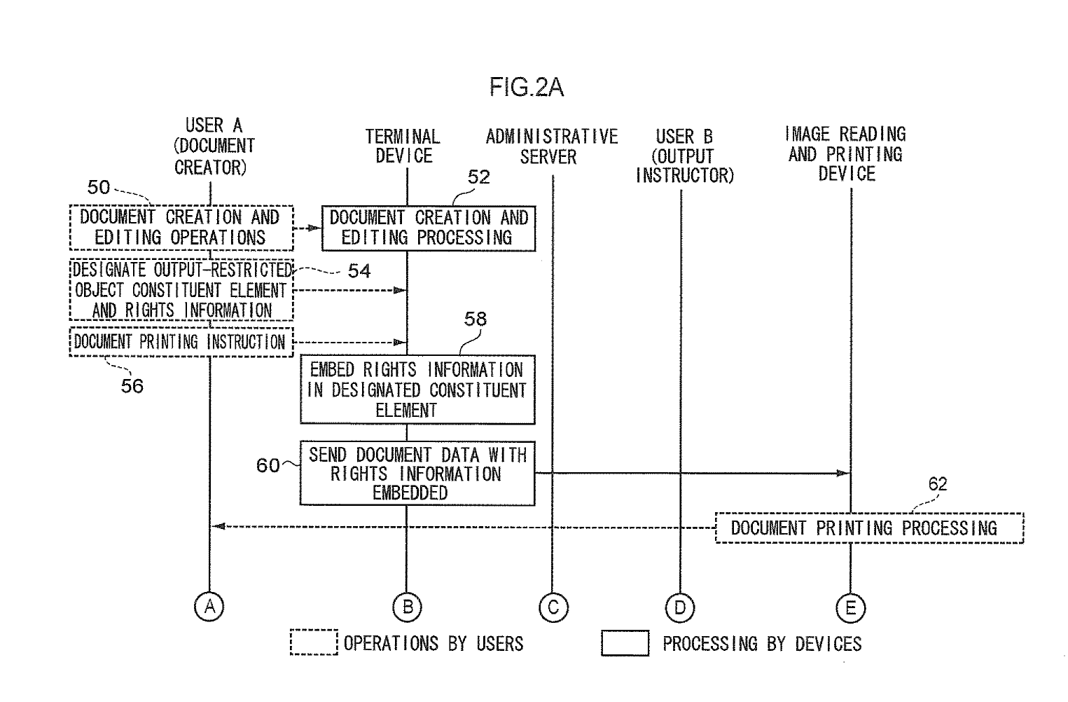

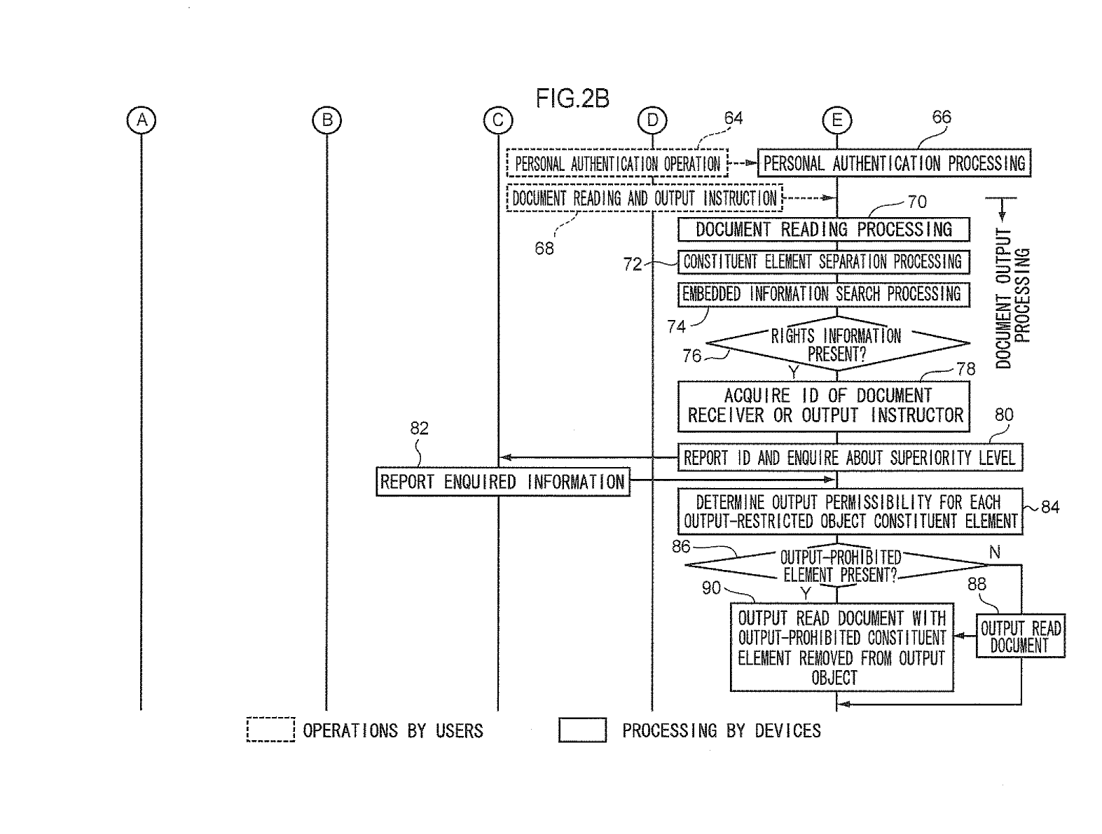

Herebelow, for a document whose desirable disclosure range differs between different document receivers, a flow from creation of the document to distribution to the document receivers is described with reference to FIGS. 2A and 2B.

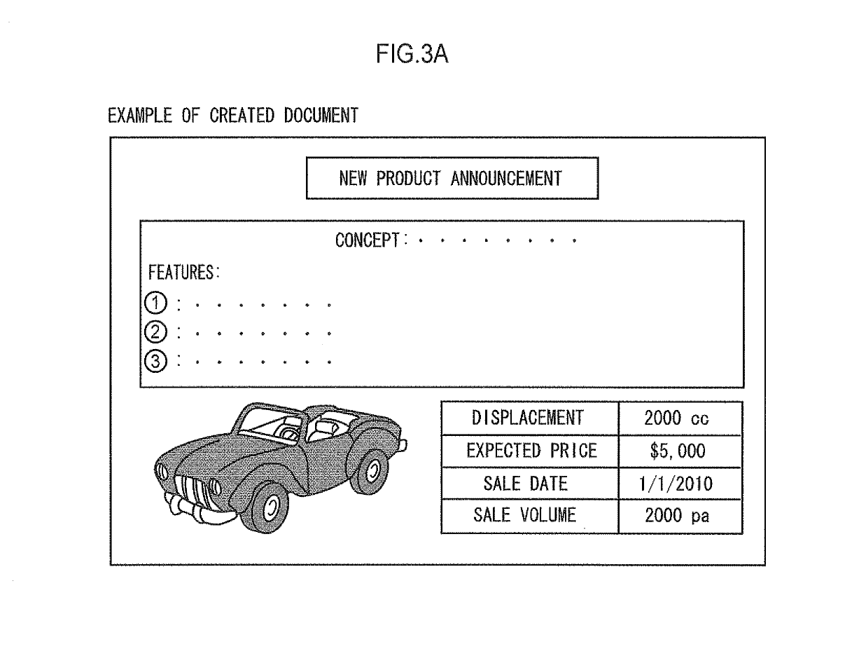

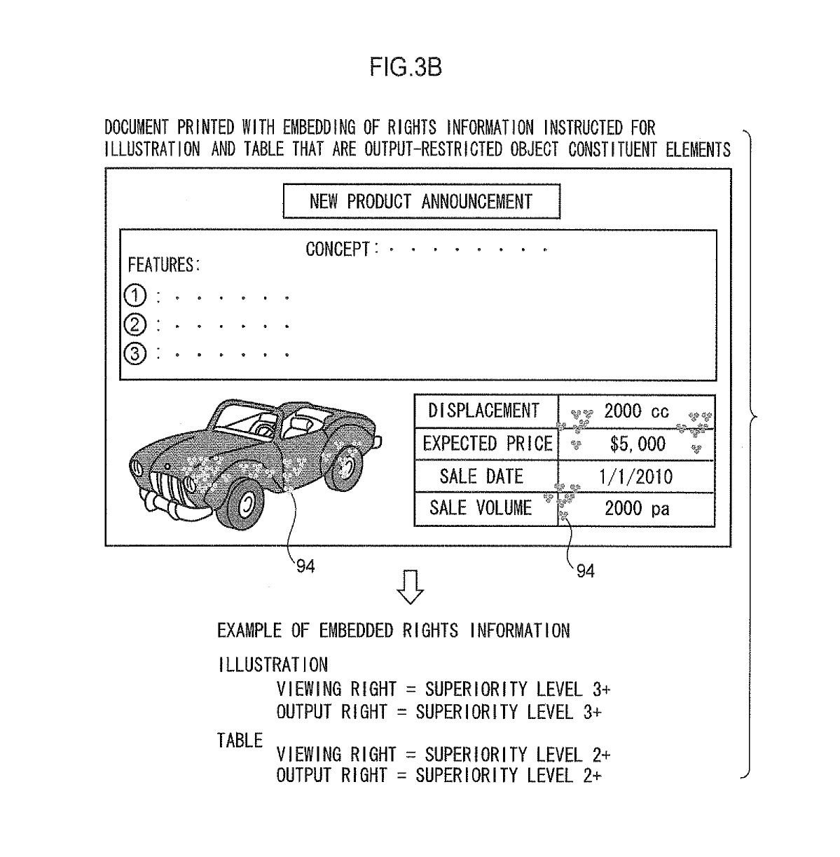

A user creating the document (a document creator) performs operations to create and edit the document by means of the keyboard 30 and mouse 32 of the terminal device 26 or the like, and the terminal device 26 performs processing to create and edit the document in accordance with the operations by the document creator (see steps 50 and 52 in FIG. 2A). Specifically, the document that the document creator creates includes at least one of text, a table, a photograph, a line image, an illustration, a chart and the like as constituent elements. For each of individual constituent elements to be disposed in the document being created, the document creator launches an application for creating and editing the particular constituent element, and performs operations using the launched application to create and edit the particular constituent element. Then, in a state in which a document creation application is running on the terminal device 26, the document creator performs operations to dispose each of the individual constituent elements that have been created and edited at required positions in the document. Thus, the document is created on the terminal device 26, for example, as illustrated in FIG. 3A.

When there is a constituent element in the created document whose disclosure (output) should be restricted in accordance with document receivers, the document creator, by means of the keyboard 30 and mouse 32 or the like, performs operations to designate a constituent element (a constituent element that is an object of output restriction, an output-restricted object constituent element) for which whether or not the constituent element should be disclosed (outputted) in the created document switches in accordance with document receivers and to respectively designate viewing rights and output rights of the designated output-restricted object constituent element (see step 54 in FIG. 2A). The output-restricted object constituent element and the output-restricted object constituent element viewing rights and output rights designated by the document creator are temporarily stored in the memory 26B by the application for document creation that is running on the terminal device 26.

Viewing rights is information that defines, by superiority levels of the document receivers, the document receivers who have the right to view an output-restricted object constituent element in the document containing the corresponding output-restricted object constituent element. Output rights is information that defines, by superiority levels of people instructing output, output instructors who have the right to output a document including an output-restricted object constituent element in a state in which the corresponding output-restricted object constituent element is shown. The viewing rights and output rights are designated by the document creator in accordance with levels of confidentiality and the like of the corresponding output-restricted object constituent elements. For example, FIG. 3B shows an example in which the viewing and output rights for the table in the document shown in FIG. 3A are designated as “superiority level 2+” (for example, administrators and above), and the viewing and output rights for the illustration, which is higher in confidentiality than the table, are designated as “superiority level 3+” (for example, managers and above). Viewing rights and output rights may be set to different superiority levels for the same output-restricted object constituent element.

Then, the document creator instructs printing of the created document (see step 56 in FIG. 2A). Hence, at the terminal device 26, processing that embeds information representing the viewing and output rights designated by the document creator (rights information) in the constituent elements designated as objects of output restriction in the document is carried out by the application for document creation that is running on the terminal device 26 (see step 58 in FIG. 2A). Thereafter, processing is carried out that sends the document data in which the rights information is embedded to the image reading and printing device 14 (see step 60 in FIG. 2A). When the image reading and printing device 14 receives this data, document printing processing is performed that prints an image of the document in which the rights information is embedded on recording paper (see step 62 in FIG. 2A). By the above-described processing, as a printed product of the document created by the document creator, a printed product is obtained in which the rights information is embedded in the constituent elements designated as objects of output restriction in the document.

Embedding of information (rights information) in (output-restricted object constituent elements of) documents has been proposed in, for example, Japanese Patent Application Laid-Open (JP-A) Nos. 06-231466, 2008-107996, 2008-112314, 2008-113215, 2008-113251 and so forth. The embedding of information in a document may be realized by creating an array pattern of dots that represents embedding object information and superimposing the created array pattern of dots on print data (bitmap data) of the document such that the individual dots are printed as dots of a particular color (for example, yellow or the like). In such a case, as is illustrated in FIG. 3B as an example, dot arrays 94 representing rights information are printed superposed on output-restricted object constituent elements in the document. FIG. 3B shows an example in which, of the constituent elements of the document shown in FIG. 3A, the illustration and the table are designated as output-restricted object constituent elements, and the dot arrays 94 are printed being superimposed on, respectively, the illustration and the table in the document.

When embedding of information in a document is performed by superimposing an array pattern of dots representing the embedding object information on print data of a document as described above, the dots printed along with the document may not be recognized when a printed product of the document is read as described hereinafter, depending on a reading resolution, and there is a risk that output rights of the output-restricted object constituent elements may be evaded by a reading resolution being deliberately set to a low resolution. However, when a reading resolution is lowered, depending on sizes of characters in a document, a recognition rate in processing for character recognition in below-described constituent element separation processing or the like also falls. When the read image is transmitted by facsimile communications or attached to an e-mail and transmitted, discerning details of the document represented by the transmitted image is difficult. Therefore, there is a lower limit on reading resolution when reading the printed product of a document (for example, not less than 200 dpi). Accordingly, when embedding of information in a document is implemented by printing a dot array, it is desirable to set sizes and spacings of the individual dots beforehand such that the dot array will be recognized even if a printed product of the document is read at the minimum reading resolution. When a document is to be created by a document creator such that characters in the document are to be recognized with at least a certain level of recognition even if a printed product of the document is read at a minimum reading resolution, it is desirable that a minimum size of the characters in the document (for example, 10 points or more) be reported to the document creator.

Embedding information in documents is not limited to employment of the above-described technology; various publicly known technologies may be employed. For example, if the constituent elements of an information embedding object are lines of text, embedding information in the document may be realized by employing a technology that, in accordance with the information of an embedding object, varies character spacings in the rows of text of the embedding information object as proposed in JP-A No. 2006-261974, or the like.

The rights information that is embedded in constituent elements designated as objects of output restriction corresponds to “first identification information” relating to the present invention. The information representing viewing rights corresponds to “rights determination information”, and the information representing output rights corresponds to the “rights determination information”.

Next, a user who has obtained a printed product of a document provided by the aforementioned processing goes to a location in which the image reading and printing device 14 is disposed, in order to distribute the document to document receivers. First, the user performs a personal authentication operation such as applying an IC card that the user carries to the card reader 24 of the image reading and printing device 14 or the like (see step 64 in FIG. 2B). Here, the printed product is a printed product in which rights information is embedded in output-restricted object constituent elements in the form of dot arrays or the like, and the user is an output instructor. This output instructor may be the same person as the document creator, and may be a different person.

Hence, personal authentication processing is performed in the image reading and printing device 14, such as a user ID recorded on the IC card carried by the output instructor and authentication information such as a password or the like being read by the card reader 24, an enquiry being sent to the administrative server 36 as to whether or not the combination of user ID and authentication information that has been read is registered in a user information table, and authentication being judged successful if the administrative server 36 reports that the combination of user ID and authentication information is registered in the user information table, or the like (see step 66 in FIG. 2B). A user information table may also be stored in the storage section 16C of the image reading and printing device 14.

When authentication of the output instructor is judged successful in the above-described personal authentication processing, the output instructor places the printed product of the document on the image reading section 18 of the image reading and printing device 14 and, via the operation section 22B of the operation panel 22, instructs reading of the placed printed product of the document and output of a reading result of the document (see step 68 in FIG. 2B). In this first exemplary embodiment, output modes of the document reading result are “facsimile transmission”, “scan-to-mail” in which the read image data is attached to an e-mail and transmitted, and “copying”. The output instructor designates any of “facsimile transmission”, “scan-to-mail” and “copying” as the output mode of the document reading result, and designates (a) transmission destination(s) (telephone number(s) or e-mail address(es)) if the transmission mode is “facsimile transmission” or “scan-to-mail”.

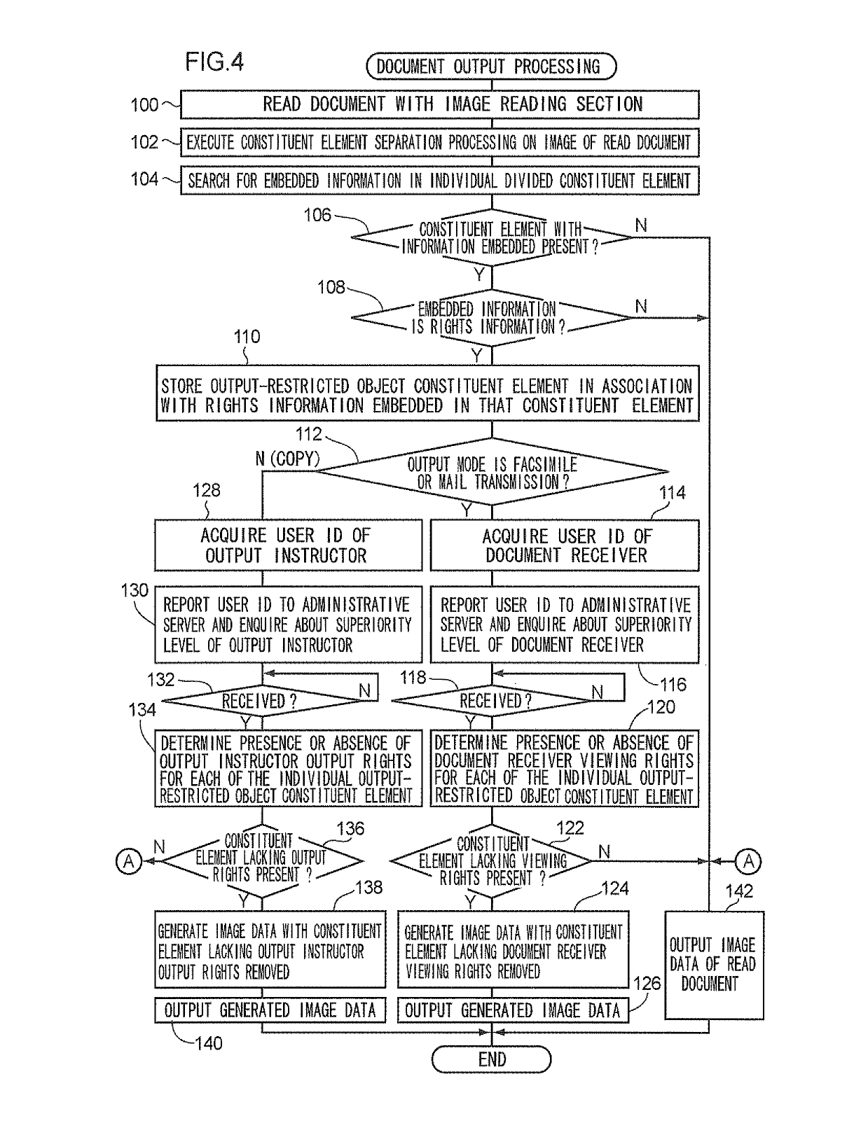

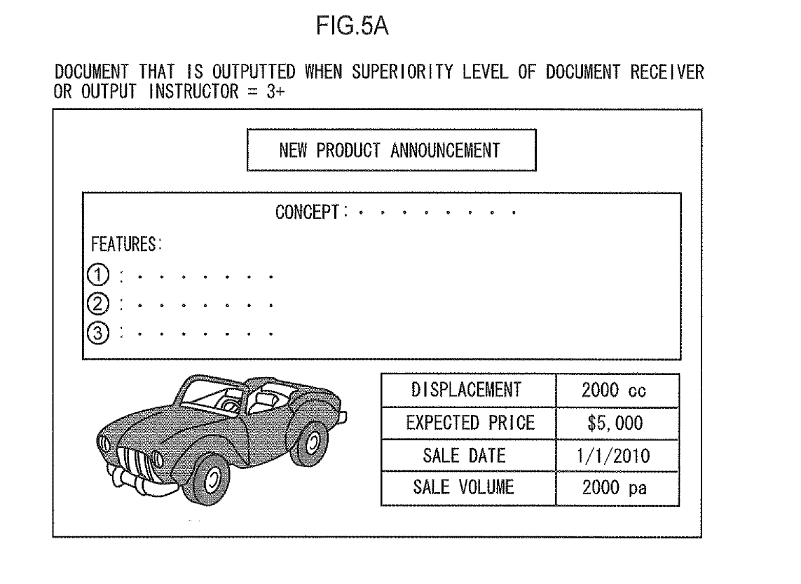

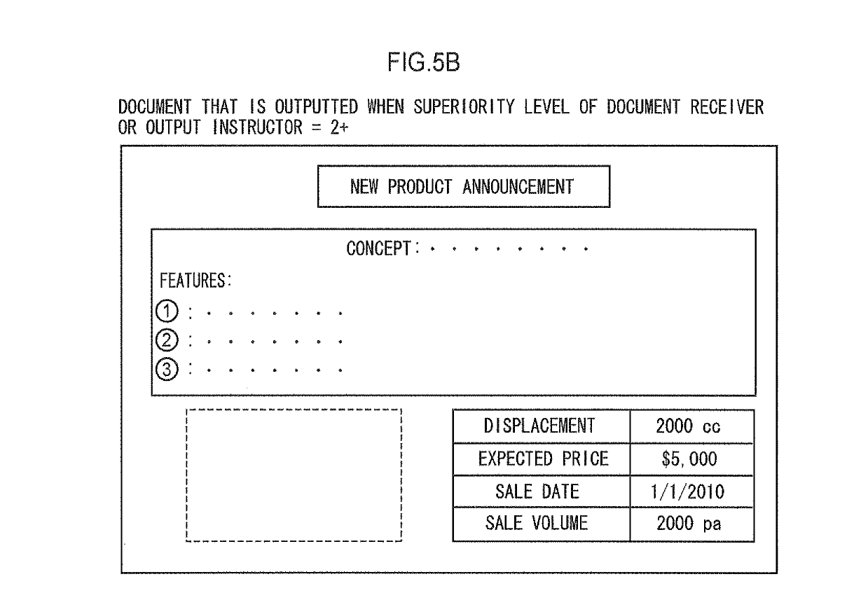

When reading and output of the document are instructed by the output instructor subsequent to the personal authentication processing as described above, in the image reading and printing device 14, a document output program is executed by the CPU 16A of the main control section 16. Thus, the document output processing illustrated in FIG. 4 is performed. Firstly, in step 100 of the document output processing, the original placed on the image reading section 18 (the printed product of a document in which rights information is embedded in output-restricted object constituent elements in the form of dot arrays or the like) is read as an image by the image reading section 18, and image data representing the document reading result obtained by this reading is stored in the storage section 16C (see step 70 in FIG. 2B).

Then, in step 102, on the basis of the image data stored in the storage section 16C, constituent element separation processing is carried out, which separates and extracts the various constituent elements of the read document image such as text, tables, photographs, line images, illustrations, charts and the like (see step 72 in FIG. 2B). Proposals relating to this constituent element separation processing are in the publications of, for example, JP-A Nos. 2006-203582 and 2006-203583, and the like. The image is divided into a number of blocks, and the blocks are categorized into a number of categories (for example, blocks of color patterns, blocks of color text with surrounding background, blocks of monochrome patterns, blocks of monochrome text with surrounding background, blocks of monochrome background, blocks of unclear attribute, and so forth) on the basis of shapes of L*, a* and b* histograms in the L*a*b* color space that are formed by each block, L*, a* and b* dispersion values and average values or the like for each block, or the like. Neighboring blocks that are categorized into the same category are combined into single regions. The read document image is separated into plural regions of mutually different categories (the constituent elements), and further processing such as character recognition or the like is applied to the regions (constituent elements) that are categorized as text. Thus, the constituent element separation processing may be realized.

Then, in step 104, searches as to whether or not rights information is embedded are respectively performed for the individual constituent elements that have been separated and extracted from the read document image by the constituent element separation processing of step 102 (see step 74 in FIG. 2B). For example, if rights information has been embedded as the aforementioned dot arrays, first, a search is performed for dots of a particular color (the color of the individual dots of the dot array) in a particular constituent element. When dots corresponding to this search are extracted, each time a dot of the particular color is extracted, a search for whether or not there are other dots of the particular color within a distance corresponding to a maximum value of dot spacing of the dot array from the extracted dot is repeated. Thus, all dots that are expected to be dots structuring the dot array are extracted. The dot array constituted by the extracted dots is converted to information represented by the dot array, and it is determined whether or not the converted information conforms to a format of rights information. Thus, searches for whether or not rights information is embedded in particular constituent elements may be performed.

In step 106, it is judged, from the results of the search processing of step 104, whether or not one or more constituent elements in which rights information is embedded have been found. If this determination is affirmative, control passes to step 108 and it is determined whether or not the information embedded in the corresponding constituent element(s) is rights information (see step 76 in FIG. 2B). If the determination of step 106 or step 108 is negative, the document for which reading and output has been instructed by the output instructor may be determined to be a document in which no output-restricted object constituent elements were designated by the document creator at the time of creating and printing the document, and control passes to step 142. In step 142, an image represented by image data of the read document (the image data obtained by the reading in the previous step 100, or reading data obtained by performing pre-specified image processing on the individual constituent elements in accordance with the results of the above-described constituent element separation processing) is outputted in the output mode designated by the output instructor, and the document output processing ends.

For example, if the output mode designated by the output instructor is facsimile transmission, the above-described image data is transmitted by facsimile communications by the communications control section 16E to each transmission destination telephone number designated by the output instructor. If the output mode designated by the output instructor is scan-to-mail, an e-mail with the above-described image data attached is created, and the created e-mail is transmitted via the network I/F section 16D with each transmission destination e-mail address designated by the output instructor as a destination. If the output mode designated by the output instructor is copying, the image represented by the above-described data is printed onto recording paper by the image printing section 20. In this case, an image of the document whose reading and output have been instructed by the output instructor is outputted as is, without some of the constituent elements in the document being excluded from output objects.

On the other hand, if one or more constituent elements in which rights information is embedded are found by the previous search processing in step 104, the determinations of steps 106 and 108 are each affirmative and control passes to step 110. In step 110, information for specifying the individual constituent elements in which rights information is embedded (the individual output-restricted object constituent elements) is stored in the memory 16B in association with the rights information embedded in the individual output-restricted object constituent elements. Then, in step 112, it is determined whether or not the output mode designated by the output instructor is one of facsimile transmission and scan-to-mail.

If the determination of step 112 is affirmative, control passes to step 114, and the user ID of the document receiver is acquired on the basis of the transmission destination designated by the output instructor (see step 78 in FIG. 2B). If the output mode is scan-to-mail, an e-mail address is designated as the transmission destination. In this case, for the acquisition of the user ID of a document receiver, e-mail addresses that are available for designation as transmission destinations of e-mails and user IDs of receivers of e-mails, which are destinations of those addresses, are registered in association in a table or such beforehand. The user ID registered in association with the e-mail address that is designated as a transmission destination by the output instructor is read from this table or such. Thus, acquisition of user IDs of the document receivers may be realized.

It is difficult to pre-register the user IDs of e-mail receivers in association in a table or such for cases in which an e-mail address designated as a transmission destination by the output instructor is directed to an e-mail receiver to whom a user ID is not assigned, cases in which an e-mail address designated as a transmission destination by the output instructor is a group address, and the like. However, in this first exemplary embodiment, the user ID acquired in step 114 is to be used for acquisition of the superiority level of each document receiver. Therefore, if a designated transmission destination is an e-mail address for which a corresponding user ID is not registered in a table or such, or is an e-mail address that is not registered in the table, or the like, the steps 116 and 118 that are described next may be skipped, and instead a superiority level of the document receiver(s) may be set to a minimum level as appropriate (for example, superiority level=1) and control passes to step 120.

When the output mode is facsimile transmission, the document receiver is often not identifiable as an individual, similarly to the aforementioned group addresses. However, among telephone numbers that are available to be specified as transmission destinations for facsimile transmissions, for telephone numbers that are identifiable as individual document receivers, telephone numbers and user IDs of the document receivers are registered in association in a table or such beforehand. When a telephone number for which the document receiver is identifiable as an individual is designated by the output instructor as a transmission destination of a facsimile transmission, the user ID registered in association with the designated telephone number is read from the table or such. When a telephone number that is not registered in this table is designated by the output instructor, the steps 116 and 118 that are described next may be skipped, and instead a superiority level of the document receiver(s) may be set to a minimum level as appropriate (for example, superiority level=1) and control passes to step 120.

If the user ID of a document receiver can be acquired in step 114, then in the next step 116, the user ID of the document receiver acquired in step 114 is sent to the administrative server 36 together with information enquiring about a superiority level of the user (document receiver) to whom this user ID is assigned (see step 80 in FIG. 2B). Then, in step 118, it is determined whether or not information reporting the superiority level of the document receiver has been received from the administrative server 36, and step 118 is repeated until this determination is affirmative. At the administrative server 36, when information enquiring about the superiority level of a document receiver is received from the image reading and printing device 14, a user information table is searched with the user ID received together with the information as a search key, a superiority level registered in association with this user ID is read from the user information table, and this superiority level is reported to the image reading and printing device 14 that is the source of the enquiry (see step 82 in FIG. 2B). Herein, the superiority level of a document receiver corresponds to the recitation “attribute information of a document receiver”, and the main control section 16 that performs the processing of step 114 to step 118 corresponds to an “acquisition unit” that acquires the attribute information of the document receiver.

When the superiority level of the document receiver is reported from the administrative server 36, the determination of step 118 is affirmative and control passes to step 120. In step 120, the document receiver superiority level reported from the administrative server 36 is compared with the viewing rights represented by the rights information of each of the individual output-restricted object constituent elements stored in the memory 16B in the previous step 110. Thus, whether or not the document receiver has viewing rights is determined for each of the individual output-restricted object constituent elements. Then, in step 122, it is determined whether or not there are any constituent elements among the output-restricted object constituent elements for which the result of the determination in step 120 is that the document receiver does not have viewing rights (see step 86 in FIG. 2B). If the determination of step 122 is negative, control passes to step 142, which is described above, image data of the read document is outputted in the output mode designated by the output instructor (see step 88 in FIG. 2B), and the document output processing ends. In this case, an image of the document whose reading and output have been instructed by the output instructor is outputted (received by the document receiver) as is, without some of the constituent elements in the document being excluded from output objects.

If the determination of step 122 is affirmative, control passes to step 124. From the image data of the read document (the image data obtained by the reading in the previous step 100 or image data obtained by applying pre-specified image processing to each of the individual constituent elements of the image data in accordance with results of the aforementioned constituent element separation processing), image data is generated from which constituent elements among the output-restricted object constituent elements for which the document receiver does not have viewing rights are removed. Then, in step 126, the image data generated in step 124 is outputted in accordance with the output mode designated by the output instructor (see step 90 in FIG. 2B), and the document output processing ends. Herein, the main control section 16 that performs the processing of step 120 to step 126 described above corresponds to a “controller” relating to the present invention.

For example, if the output mode designated by the output instructor is facsimile transmission, the image data generated in step 124 is transmitted by facsimile communications by the communications control section 16E to the transmission destination telephone number designated by the output instructor. If the output mode designated by the output instructor is scan-to-mail, an e-mail with the image data generated in step 124 attached is created, and the created e-mail is transmitted via the network I/F section 16D with the transmission destination e-mail address designated by the output instructor as the destination. In these cases, the document receiver receives an image in which constituent elements for which the document receiver does not have viewing rights are removed (erased) from the document for which reading and output have been instructed by the output instructor.

If the output mode designated by the output instructor is copying, the determination of step 112 is negative, control passes to step 128, and the user ID of the output instructor acquired by the previous personal authentication processing (see step 66 in FIG. 2B) is read from the memory 16B or the like (see step 78 in FIG. 2B). Then, in step 130, the user ID of the output instructor acquired in step 128 is sent to the administrative server 36 together with information enquiring about the superiority level of the user (the output instructor) to whom this user ID is assigned (see step 80 in FIG. 2B). Then, in step 132, it is determined whether or not information reporting the superiority level of the output instructor has been received from the administrative server 36, and step 132 is repeated until this determination is affirmative. Herein, the superiority level of the output instructor corresponds to the recitation “attribute information of an output instructor”, and the main control section 16 that performs the processing of step 128 to step 132 corresponds to an “acquisition unit” that acquires the attribute information of the output instructor.

As described previously, at the administrative server 36, when information enquiring about the superiority level of the output instructor is received from the image reading and printing device 14, a user information table is searched with the user ID received together with the information as a search key, a superiority level registered in association with this user ID is read from the user information table, and this superiority level is reported to the image reading and printing device 14 that is the source of the enquiry (see step 82 in FIG. 2B).

When the superiority level of the output instructor is reported from the administrative server 36, the determination of step 132 is affirmative and control passes to step 134. In step 134, the output instructor superiority level reported from the administrative server 36 is compared with the output rights represented by the rights information of each of the individual output-restricted object constituent elements stored in the memory 16B in the previous step 110. Thus, whether or not the document receiver has output rights or not is determined for each of the individual output-restricted object constituent elements. Then, in step 136, it is determined whether or not there are any constituent elements among the output-restricted object constituent elements for which the result of the determination in step 134 is that the document receiver does not have output rights (see step 86 in FIG. 2B). If the determination of step 136 is negative, control passes to step 142, which is described above, image data of the read document is outputted in the output mode designated by the output instructor (see step 88 in FIG. 2B; this is a case of printing onto recording paper with the image printing section 20), and the document output processing ends. In this case, an image of the document whose reading and output have been instructed by the output instructor is printed on the recording paper as is, without some of the constituent elements in the document being excluded from output objects.

If the determination of step 136 is affirmative, control passes to step 138. From the image data of the read document (the image data obtained by the reading in the previous step 100 or image data obtained by applying pre-specified image processing to each of the individual constituent elements of the image data in accordance with results of the aforementioned constituent element separation processing), image data is generated from which constituent elements among the output-restricted object constituent elements for which the output instructor does not have output rights are removed. Then, in step 140, the image data generated in step 138 is printed on recording paper by the image printing section 20 (see step 90 in FIG. 2B), and the document output processing ends. In this case, an image is printed onto the recording paper in which constituent elements for which the output instructor does not have output rights are removed (erased) from the document for which reading and output have been instructed by the output instructor. Herein, the main control section 16 that performs the processing of step 134 to step 140 corresponds to the “controller” relating to the present invention.

### Second Exemplary Embodiment

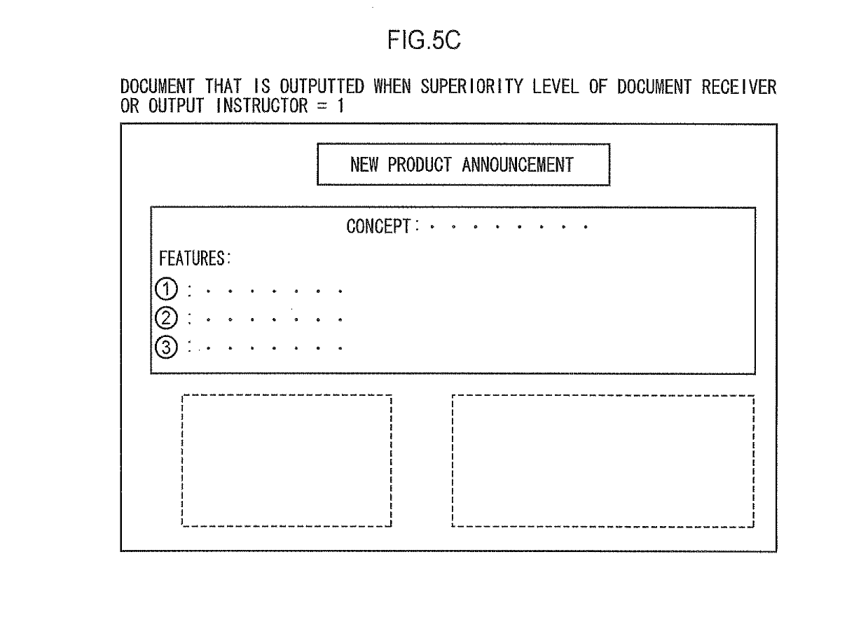

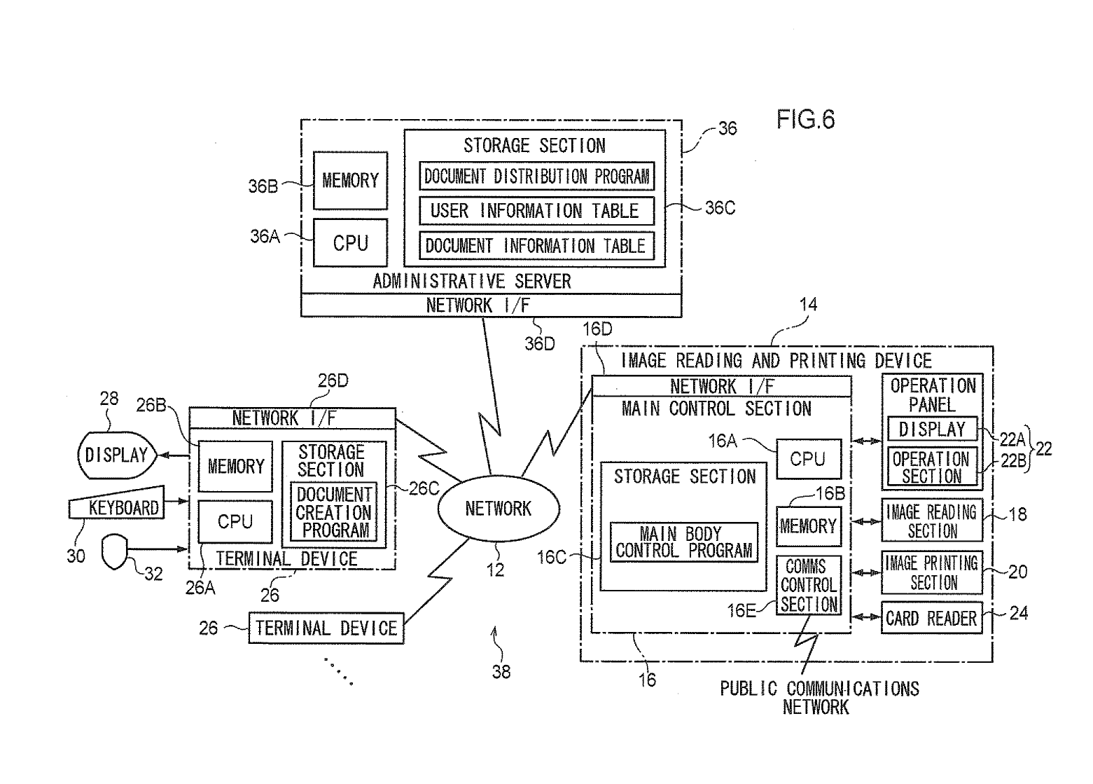

Next, a second exemplary embodiment of the present invention is described. Portions the same as in the first exemplary embodiment are assigned the same reference numerals and are not described. FIG. 6 illustrates a computer system 38 relating to the second exemplary embodiment.

The computer system 38 relating to this second exemplary embodiment differs from the computer system 10 relating to the first exemplary embodiment in that rather than the document output program being installed at the storage section 16C of the image reading and printing device 14, a document distribution program is installed at the storage section 36C of the administrative server 36. A document information table for registering information about a document, including output-restricted object constituent elements, is stored in the storage section 36C of the administrative server 36 and, although not illustrated, a program for causing the administrative server 36 to function as a web server is installed at the storage section 36C. The above document distribution program of this second exemplary embodiment also corresponds to the document output program relating to the present invention and, by the CPU 36A executing the document distribution program, the administrative server 36 relating to the second exemplary embodiment functions as the document output device relating to the present invention.

Next, operations of this second exemplary embodiment are described. In this second exemplary embodiment, printing of a document onto recording paper, reading of the document printed onto recording paper, and uploading of data of the document obtained by reading to the image reading section 18 are performed in accordance with the instructions of a document creator. Distribution of the document created by the document creator is implemented by (data of) the document uploaded to the image reading section 18 being viewed (or downloaded) by another user (a document outputter). Herebelow, a flow in this second exemplary embodiment, from creation to distribution to a document outputter (i.e., viewing (or downloading) by the document outputter), is described for a document in which a desirable scope of disclosure differs between document outputters.

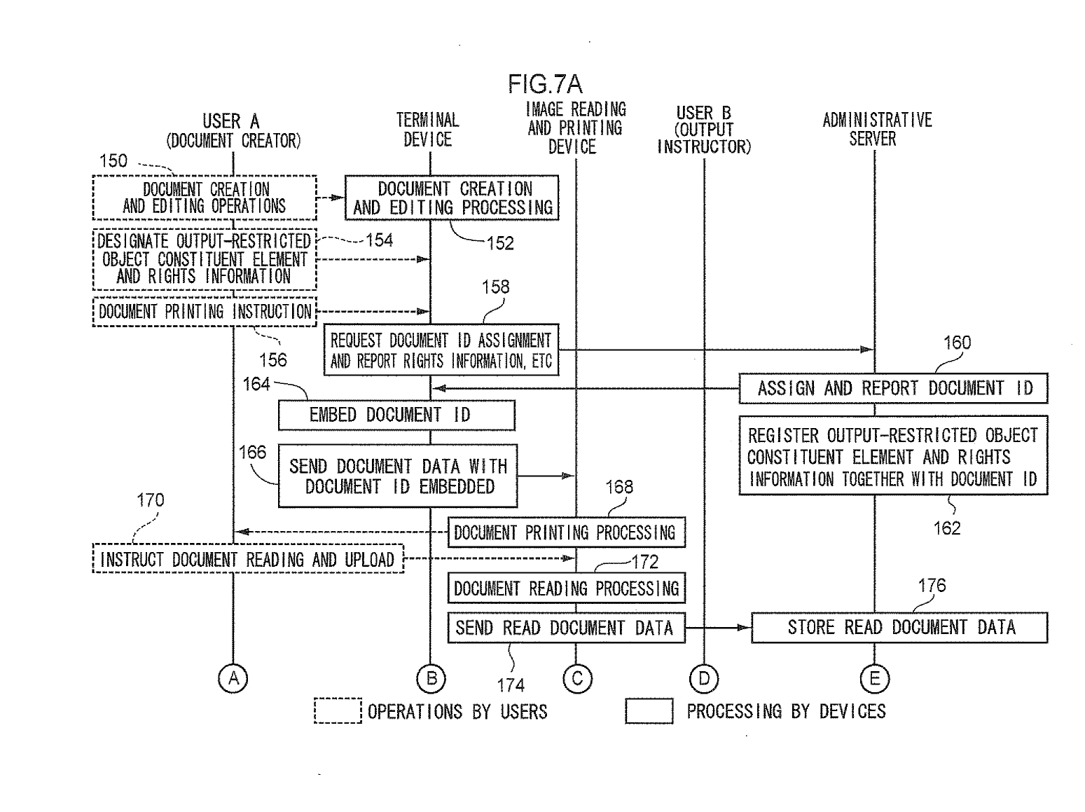

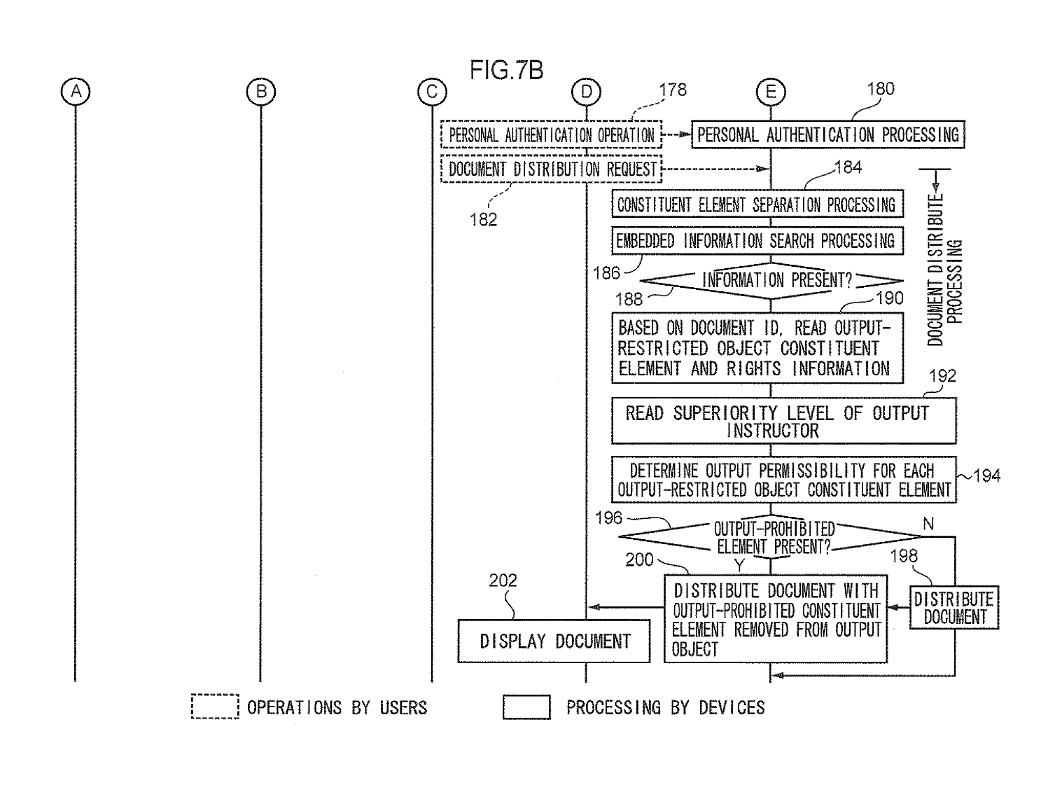

In this second exemplary embodiment too, a document creator performs operations to create and edit a document by means of the keyboard 30 and mouse 32 of the terminal device 26 or the like, and the terminal device 26 performs processing to create and edit the document in accordance with the operations by the document creator (see steps 150 and 152 in FIG. 7A). When there is a constituent element in the created documents whose disclosure (output) should be limited in accordance with document receivers, the document creator, by means of the keyboard 30 and mouse 32 or the like, performs operations to designate a constituent element for which whether or not the constituent element should be disclosed (outputted) in the created document switches in accordance with document receivers (an output-restricted object constituent element) and to designate respective output rights of the designated output-restricted object constituent element (see step 154 in FIG. 7A). The output-restricted object constituent element and the output-restricted object constituent element output rights designated by the document creator are temporarily stored in the memory 26B by the application for document creation that is running on the terminal device 26.

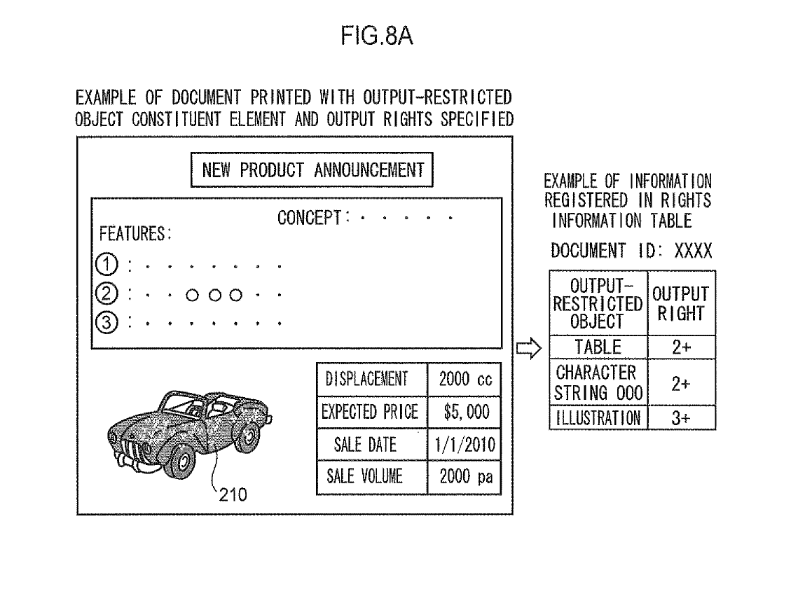

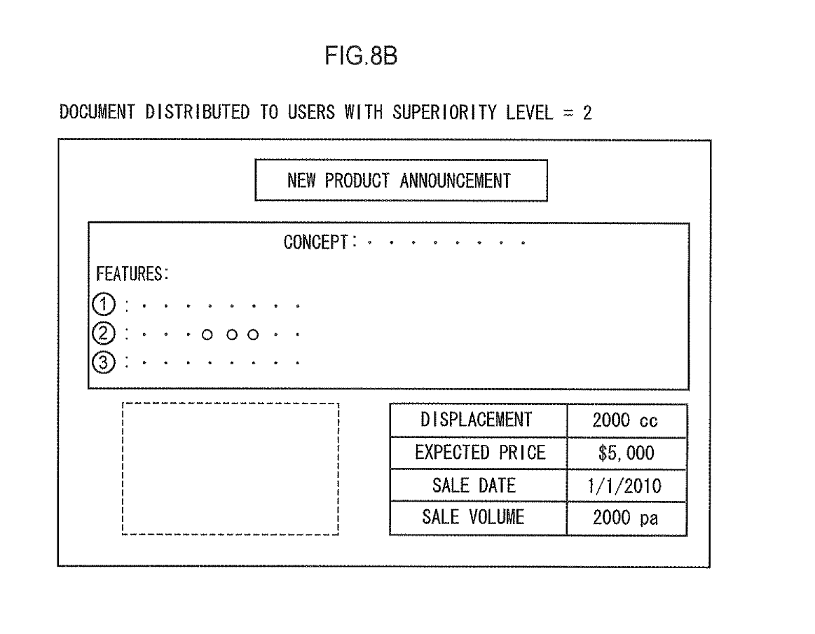

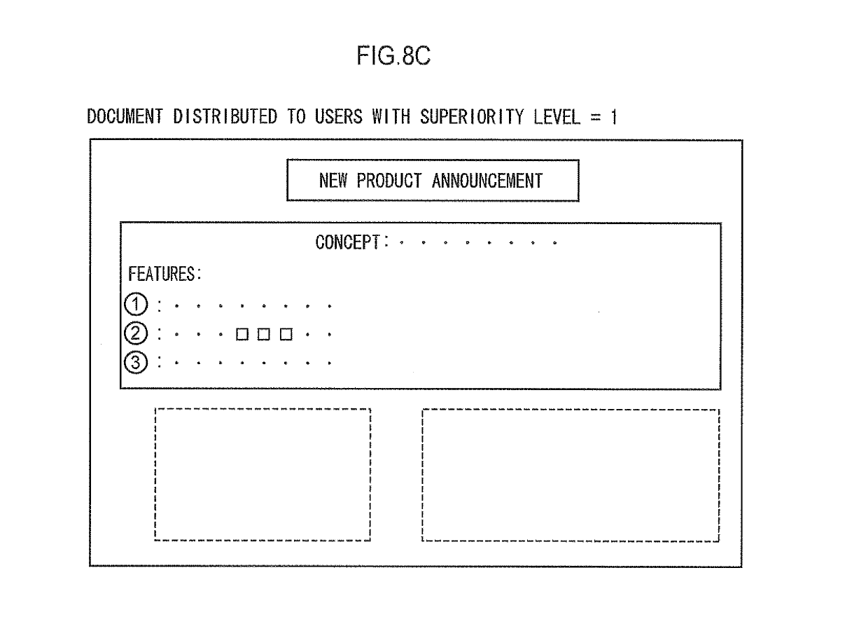

In the first exemplary embodiment, an output-restricted object constituent element is defined by printing a dot array representing rights information superimposed on the output-restricted object constituent element in the document (an output-restricted object constituent element=the output-restricted object constituent element with a dot array representing rights information superimposed thereon). Instead of this, in the second exemplary embodiment, the information defining an output-restricted object constituent element, as described below, is stored in the storage section 36C of the administrative server 36 (more specifically, registered in a document information table stored in the storage section 36C). The information defining output-restricted object constituent elements is set up such that boundaries between output-restricted object constituent elements and constituent elements that are not objects of output restriction are definite. Thus, output-restricted object constituent elements may be designated with smaller constituent elements in the document being defined as minimum units than in the first exemplary embodiment. Accordingly, FIG. 8A shows an example in which, in addition to the table and illustration described for the first exemplary embodiment, the character string “OOO” that is present in the document is also designated as an output-restricted object constituent element.

Then, the document creator instructs printing of the created document (see step 156 in FIG. 7A). Accordingly, information requesting the assignment of information for identifying the document created by the document creator (a document ID) is sent from the terminal device 26 to the administrative server 36 together with information defining the output-restricted object constituent elements designated by the document creator and information representing the output rights of the output-restricted object constituent elements (see step 158 of FIG. 7A). Hence, the administrative server 36 assigns a new document ID in response to the request from the terminal device 26, and reports the new assigned document ID to the terminal device 26 (see step 160 in FIG. 7A). The administrative server 36 registers the information reported from the terminal device 26 (the information defining the output-restricted object constituent elements and the information representing the output rights of the output-restricted object constituent elements) in the document information table in association with the above assigned document ID (see step 162 in FIG. 7A). Herein, the document ID corresponds to “document identification information”, and the information registered in the document information table in association with the document ID corresponds to “information of the constituent element specified as the object of output restriction”.

At the terminal device 26, when the document ID is reported from the administrative server 36, processing that embeds the reported document ID in the document created by the document creator, as a dot array or the like as described in the first exemplary embodiment, is carried out by the application for document creation that is running on the terminal device 26 (see step 164 in FIG. 7A). Thereafter, processing is carried out that sends data of the document in which the document ID is embedded to the image reading and printing device 14 (see step 166 in FIG. 7A). Document printing processing that prints an image of the document in which the document ID is embedded on recording paper is carried out by the image reading and printing device 14 receiving the data (see step 168 in FIG. 7A). By the above-described processing, as a printed product of the document created by the document creator, a printed product of the document is obtained in which, for example, as illustrated in FIG. 8A, a dot array 210 representing the document ID is superimposedly printed.

FIG. 8A illustrates an example in which the dot array 210 representing the document ID is superimposedly printed on the illustration with the highest superiority level defining output rights among the output-restricted object constituent elements. However, the dot array 210 representing the document ID may be superimposedly printed on any constituent element in a document (regardless of whether it is an object of output restriction or not), and may be printed on a blank portion of a document.

Then, the document creator places the printed product of the document acquired by the processing described above on the image reading section 18 of the image reading and printing device 14 and, via the operation section 22B of the operation panel 22, instructs reading of the placed printed product of the document and uploading of the same to the administrative server 36 (see step 170 in FIG. 7A). Accordingly, at the image reading and printing device 14, first, the original placed on the image reading section 18 (the printed product of the document in which the document ID is embedded in the form of a dot array or the like) is read as an image by the image reading section 18, and image data representing a reading result of the document obtained by this reading is sent to the administrative server 36 (see step 172 in FIG. 7A). At the administrative server 36 receiving the read document data from the image reading and printing device 14, the read document data is stored in the storage section 36C in a form that is accessible for other users via the terminal devices 26 and the network 12 (see step 176 in FIG. 7A).

When uploading of the created document to the administrative server 36 as described above is complete, the document creator reports that a distribution object document has been uploaded to the administrative server 36 by sending e-mails to users who are set as distribution targets of the created document, or the like. A user receiving this report (an output instructor) first performs a personal authentication operation, such as inputting their user ID and authentication information such as a password or the like via the keyboard 30 of the terminal device 26 (see step 178 in FIG. 7B). Accordingly, the administrative server 36 performs personal authentication processing, such as determining whether or not the combination of user ID and authentication information inputted by the output instructor is registered in the user information table and determining that authentication is successful if the combination of user ID and authentication information is registered in the user information table, or the like (see step 180 in FIG. 7B).

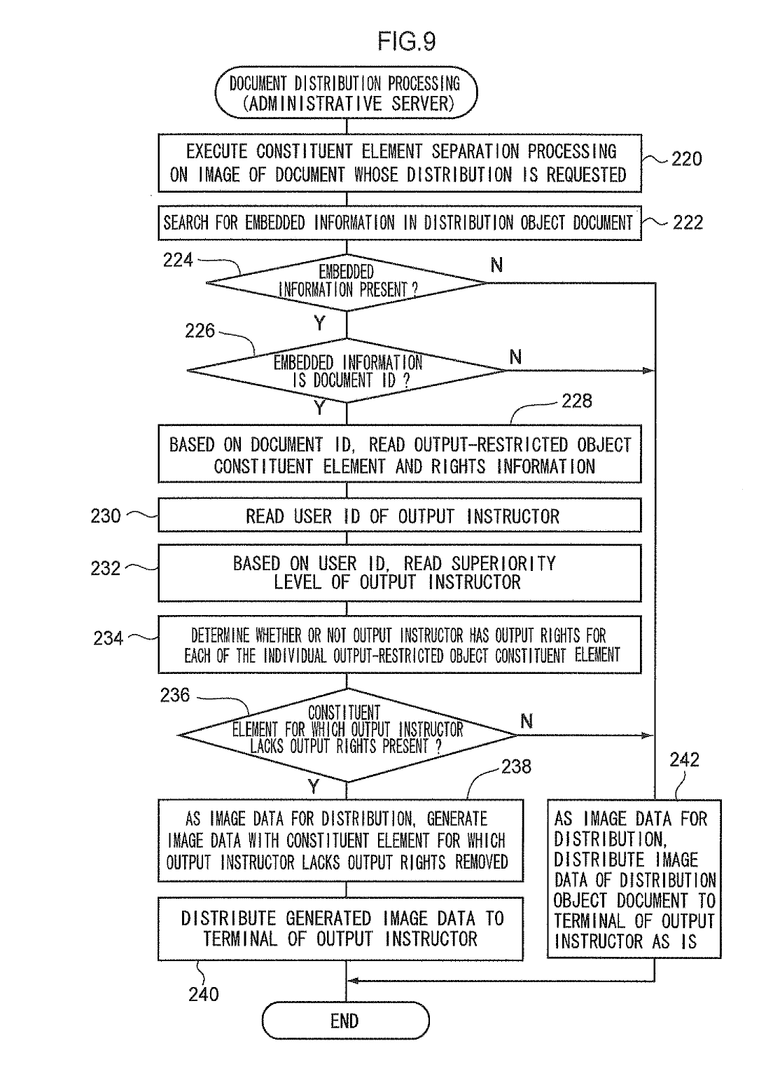

When authentication by the above-described personal authentication processing is determined to be successful, the output instructor makes a request to the administration server for distribution (or downloading) of the document whose upload to the administrative server 36 has been reported by the document creator. Accordingly, a document distribution program is executed by the CPU 36A at the administrative server 36, and the document distribution processing illustrated in FIG. 9 is carried out.

First in this document distribution processing, in step 220, on the basis of the image data that is stored in the storage section 36C and whose distribution has been requested by the output instructor, constituent element separation processing is carried out that separates and extracts the various constituent elements of the distribution object document image, such as text, tables, photographs, line images, illustrations, charts and the like (see step 184 in FIG. 7B). Then, in step 222, a search as to whether or not any information is embedded is performed on the distribution object document image on which the constituent element separation processing has been carried out in step 220 (see step 186 in FIG. 7B). In step 224, it is determined whether or not the result of the search processing of step 222 is that some information is embedded in the distribution object document (see step 188 in FIG. 7B). If this determination is affirmative, control passes to step 226, and it is determined whether or not the information embedded in the distribution object document is a document ID.

If the determination of step 224 or step 226 is negative, the document for which distribution has been requested by the output instructor may be determined to be a document in which no output-restricted object constituent elements were designated by the document creator at the time of creating and printing the document, and control passes to step 242. In step 242, image data of the distribution object document (the image data uploaded from the image reading and printing device 14, or image data obtained by performing pre-specified image processing on the individual constituent elements in accordance with the results of the above-described constituent element separation processing) is sent (distributed) to the terminal device 26 being operated by the output instructor, and the document distribution processing ends. In this case, an image of the document whose distribution has been requested by the output instructor is displayed, as is, at the display 28 of the terminal device 26 being operated by the output instructor, without some of the constituent elements in the document being excluded from output objects.

On the other hand, if a document ID embedded in the distribution object document is found by the previous search processing in step 222, the determinations of steps 224 and 226 are each affirmative and control passes to step 228. In step 228, the document information table is searched with the document ID embedded in the distribution object document as a search key, and information that defines output-restricted object constituent elements in the distribution object document and information representing output rights of the individual output-restricted object constituent elements are read from the document information table and stored in the memory 36B (see step 190 in FIG. 7). In step 230, the user ID of the output instructor acquired in the personal authentication processing described above (see step 180 in FIG. 7B) is read into the memory 36B. Then, in step 232, the user information table is searched with the user ID of the output instructor read in step 230 as a search key, and the superiority level of the output instructor is read from the user information table into the memory 36B (see step 192 in FIG. 7B). Herein, the superiority level of an output instructor corresponds to the recitation “attribute information of an output instructor”, and the administrative server 36 that performs the processing of steps 230 and 232 corresponds to the “acquisition unit” that acquires the attribute information of the output instructor.

Then, in step 234, the output instructor superiority level stored in the memory 16B in step 232 is compared with the output rights represented by the rights information of each of the individual output-restricted object constituent elements stored in the memory 16B in the previous step 228. Thus, whether or not the output instructor has output rights is determined for each of the individual output-restricted object constituent elements. Then, in step 236, it is determined whether or not there are any constituent elements among the output-restricted object constituent elements for which the result of the determination in step 234 is that the output instructor does not have output rights (see step 196 in FIG. 7B). If the determination of step 236 is negative, control passes to step 242, which is described above, image data of the distribution object document is sent (distributed) to the terminal device 26 being operated by the output instructor (see step 198 in FIG. 7B), and the document distribution processing ends. In this case too, an image of the document whose distribution has been requested by the output instructor is displayed as is at the display 28 of the terminal device 26 being operated by the output instructor, without some of the constituent elements in the document being excluded from output objects.

If the determination of step 236 is affirmative, control passes to step 238. From the image data of the distribution object document (the image data uploaded from the image reading and printing device 14 or image data obtained by applying pre-specified image processing to each of the individual constituent elements of the image data in accordance with results of the aforementioned constituent element separation processing), image data is generated from which constituent elements among the output-restricted object constituent elements for which the output instructor does not have output rights are removed. Then, in step 240, the distribution object document image data generated in step 238 is sent (distributed) to the terminal device 26 being operated by the output instructor (see step 200 in FIG. 7B), and the document output processing ends. Thus, at the display 28 of the terminal device 26 being operated by the output instructor, an image is displayed in which constituent elements for which the output instructor does not have output rights are removed (erased) from the distribution object document whose distribution has been requested by the output instructor. Herein, the administrative server 36 that performs the processing of step 234 to step 240 corresponds to the “controller” relating to the present invention.

For example, as illustrated in FIG. 8A, the output rights for the table and the character string “OOO” in the document are set to superiority level 2+, and the output rights for the illustration are set to superiority level 3+. When distribution is requested by a user (output instructor) of superiority level 2, the output instructor lacks output rights only for the illustration in the document, so an image in which only the illustration is removed (erased) from the document as illustrated in FIG. 8B is distributed to the terminal device 26 being operated by the output instructor as the distribution object document image, and this image is displayed at the display 28 of the terminal device 26. When distribution of the document illustrated in FIG. 8A is requested by a user (output instructor) of superiority level 1, the output instructor lacks output rights for the illustration, the table and the character string “OOO” in the document, so an image in which the illustration, the table and the character string “OOO” are each removed (erased) from the document as illustrated in FIG. 8C is distributed to the terminal device 26 being operated by the output instructor as the distribution object document image, and this image is displayed at the display 28 of the terminal device 26.

In the first exemplary embodiment, a mode is described in which a document in which rights information designated by a document creator is embedded is printed onto recording paper, but the present invention is not to be limited thus. Similarly to the second exemplary embodiment, a document in which a document ID is embedded may be printed onto recording paper and rights information designated by the document creator stored in association with the document ID in a separate storage unit (for example, the storage section 36C of the administrative server 36).

In the second exemplary embodiment, a case is described in which a document in which a document ID is embedded is printed onto recording paper and rights information designated by a document creator is stored in the storage section 36C of the administrative server 36 in association with the document ID, but the present invention is not to be limited thus. Similarly to the first exemplary embodiment, a document in which rights information designated by the document creator is embedded may be printed onto recording paper.

Hereabove, it is determined whether or not to output an output-restricted object constituent element by comparing the viewing rights or output rights represented by the rights information designated by the document creator with the superiority level of a document receiver or output instructor, but the present invention is not to be limited thus. For example, a constitution as follows is possible. Authentication information such as passwords or the like is designated by the document creator in units of the individual output-restricted object constituent elements. A document in which the designated authentication information is embedded is printed on recording paper, or the designated authentication information is stored in a separate memory (for example, the storage section 36C of the administrative server 36) in association with a document ID (and the document ID is embedded in the document and printed onto the recording paper). Authentication information is inputted by an output instructor. When the authentication information inputted by the output instructor matches the authentication information designated by the document creator, the output-restricted object constituent element is outputted, but if the authentication information inputted by the output instructor does not match the authentication information designated by the document creator, the output-restricted object constituent element is not outputted. Here, the authentication information designated by the document creator corresponds to “first identification information” and “first authentication information” relating to the present invention, and the authentication information inputted by the output instructor corresponds to “second identification information” and “second authentication information” relating to the present invention.

The above-described output-restricted object constituent element output permission determination that uses authentication information such as a password or the like and output-restricted object constituent element output permission determination that uses rights information may be combined. For example, even if an output instructor does not have output rights for an output-restricted object constituent element according to the rights information, processing may be performed to output the output-restricted object constituent element if authentication information inputted by the output instructor matches authentication information embedded in the document, or the like.

A mode is described above in which output-restricted object constituent elements (for example, illustrations and tables, particular character strings and the like in a document) are directly designated by the document creator, but the present invention is not to be limited thus. A document creator may designate the range of a region in a created document in which output-restricted object constituent elements are present, and constituent elements that are present in the designated range of the document may be stored as objects of output restriction (embedded in the document or stored in a separate memory). The range designated by the document creator may be stored as information defining the output-restricted object constituent elements, and constituent elements in the range determined as being output-restricted object constituent elements when output of the document is instructed.

A mode is described above in which processing that removes (erases) output-restricted object constituent elements is carried out to serve as processing that restricts output of output-restricted object constituent elements, but the present invention is not to be limited thus. Processing may be performed that replaces an output-restricted object constituent element with a pre-specified line image (for example, a pre-specified graphic or a frame showing the outer edge of the output-restricted object constituent element, or the like). Processing is also possible that divides an image of an output-restricted object constituent element into plural regions that are respectively constituted of plural pixels and replaces each region with an image in which the densities of the individual pixels in the region are made uniform (which is known as pixelization processing).

Hereabove, a mode is described in which the document output program relating to the present invention is stored (installed) at the storage section 16C of the image reading and printing device 14, but the document output program relating to the present invention may be provided in a mode of being recorded on a storage medium such as a CD-ROM, a DVD-ROM or the like.

The foregoing description of the embodiments of the present invention has been provided for the purpose of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to be suited to the particular use contemplated. It is intended that the scope of the invention be defined by the following claims and their equivalents.

What is claimed is:

1. A document output device comprising:
an acquisition unit that acquires at least one of attribute information of a document receiver who is to receive an outputted document, attribute information of an output instructor, or second identification information inputted by the output instructor, when a printed document is read with a reading device, and output of the document on the basis of read document information acquired by the reading is instructed; and
a controller that controls output of the document so as to restrict output of a constituent element which is an object of output restriction in the document to be outputted on the basis of the read document information, if it is determined that the output of the constituent element specified as the object of output restriction is not permitted on the basis of a first identification information which is extracted from the read document information, and the information acquired by the acquisition unit.

2. The document output device according to claim 1, wherein
the document is printed with the first identification information embedded in the constituent element specified as the object of output restriction in the document, and
the controller identifies a constituent element in which the first identification information is embedded in the printed document as the constituent element specified as the object of output restriction.

3. The document output device according to claim 1, wherein
information of the constituent element specified as the object of output restriction in the document is stored in a memory in association with document identification information which is included in the first identification information which is embedded in the document when the document is printed, and
the controller identifies the constituent element specified as the object of output restriction on the basis of the information that is stored in the memory in association with the document identification information which is included in the first identification information which is extracted from the read document information.

4. The document output device according to claim 1, wherein
the document is printed with the first identification information embedded in the constituent element specified as the object of output restriction in the document, and
the controller identifies a constituent element in which the first identification information is embedded in the printed document as the constituent element specified as the object of output restriction, or
information of the constituent element specified as the object of output restriction in the document is stored in a memory in association with document identification information which is included in the first identification information which is embedded in the document when the document is printed, and
the controller identifies the constituent element specified as the object of output restriction on the basis of the information that is stored in the memory in association with the document identification information which is included in the first identification information which is extracted from the read document information.

5. The document output device according to claim 4, wherein
the first identification information, which is embedded in the document or in the constituent element specified as the object of output restriction when the document is printed, or the information of the constituent element, which is stored in the memory in association with the document identification information when the document is printed, comprises rights determination information for determining a user who has a right to view the constituent element specified as the object of output restriction,
the attribute information of the document receiver that is acquired by the acquisition unit, or information that is stored in the memory in association with user identification information which is included in the attribute information of the document receiver, comprises rights information that defines rights specified in advance for a user who is the document receiver, and
the controller determines the permissibility of output of the constituent element specified as the object of output restriction by matching the rights information with the rights determination information and determining whether or not the document receiver has the right to view the constituent element specified as the object of output restriction.

6. The document output device according to claim 4, wherein
the first identification information, which is embedded in the document or in the constituent element specified as the object of output restriction when the document is printed, or the information of the constituent element, which is stored in the memory in association with the document identification information when the document is printed, comprises rights determination information for determining a user who has a right to output the constituent element specified as the object of output restriction,
the attribute information of the output instructor that is acquired by the acquisition unit, or information that is stored in the memory in association with user identification information which is included in the attribute information of the output instructor comprises rights information that defines rights specified in advance for a user who is the output instructor, and
the controller determines the permissibility of output of the constituent element specified as the object of output restriction by matching the rights information with the rights determination information and determining whether or not the output instructor has the right to output the constituent element specified as the object of output restriction.

7. The document output device according to claim 4, wherein
the first identification information, which is embedded in the document or in the constituent element specified as the object of output restriction when the document is printed, or the information of constituent element, which is stored in the memory in association with the document identification information when the document is printed, comprises first authentication information, and
the controller determines the permissibility of output of the constituent element specified as the object of output restriction by determining whether or not second authentication information which is included in the second identification information acquired by the acquisition unit matches the first authentication information.

8. The document output device according to claim 1, wherein the controller restricts the output of the constituent element which is the object of output restriction in the document by, with respect to the constituent element specified as the object of output restriction in the document, not outputting the constituent element, replacing the constituent element with a pre-specified line image and outputting the same, or dividing an image of the constituent element into a plurality of regions that are respectively constituted by pluralities of pixels, replacing each region with an image in which densities of the plurality of pixels in the region are made equal and outputting the same.

9. The document output device according to claim 1, wherein at least one of a particular category of constituent element among a plurality of categories of constituent element in the document, a constituent element that is present in a particular region that is specified as the object of output restriction in the document, or a particular character string in the document is specified as the constituent element which is the object of output restriction.

10. A computer readable medium storing a program causing a computer to execute a process for outputting a document, the process comprising:
acquiring at least one of attribute information of a document receiver who is to receive the outputted document, attribute information of an output instructor, or second identification information inputted by the output instructor when a printed document is read with a reading device, and output of the document on the basis of read document information acquired by the reading is instructed, and
controlling output of the document so as to restrict output of a constituent element which is an object of output restriction in the document to be outputted on the basis of the read document information, if it is determined that the output of the constituent element specified as the object of output restriction is not permitted on the basis of a first identification information which is extracted from the read document information and the acquired information.

11. A document output method comprising:
acquiring at least one of attribute information of a document receiver who is to receive the outputted document, attribute information of an output instructor, or second identification information inputted by the output instructor when a printed document is read with a reading device, and output of the document on the basis of read document information acquired by the reading is instructed, and
controlling output of the document so as to restrict output of a constituent element which is an object of output restriction in the document to be outputted on the basis of the read document information, if it is determined that the output of the constituent element specified as the object of output restriction is not permitted on the basis of a first identification information which is extracted from the read document information and the acquired information.
